(19) United States
(12) Patent Application Publication
(10) Pub. No.: US 2011/0096994 A1
(43) Pub. Date: Apr. 28, 2011

(54) Similar image retrieval system and similar image retrieval method

(75) Inventors: Seiichi Hirai, Kodaira-shi (JP); Sumie Nakabayashi, Kodaira-shi (JP); Hideaki Uchikoshi, Kodaira-shi (JP)

(73) Assignee: HITACHI KOKUSAI ELECTRIC INC., Tokyo (JP)

(21) Appl. No.: 12/805,351

(22) Filed: Jul. 27, 2010

(30) Foreign Application Priority Data
Oct. 22, 2009 (JP) 2009-243044

(51) Int. Cl. G06K 9/46

(52) U.S. Cl. 382/190

(57) ABSTRACT

A similar image retrieval system stores image data of picked-up images; extracts features of the respective picked-up images to store with the image data; specifies a key image; and retrieves an image having a high similarity with the key image by evaluating similarities between the key image and the picked-up images based on a feature of the key image and those of the picked up images. The system includes: a unit for assigning a keyword to each image; a first image retrieval unit for retrieving a similar image to the key image while excluding an image with the keyword from a retrieval target; and a second image retrieval unit for retrieving a similar image to the key image while taking only an image with the keyword as a retrieval target.

### FIELD OF THE INVENTION

The present invention relates to a similar image retrieval system and a similar image retrieval method, and more particularly, to a similar image retrieval system and a similar image retrieval method, in which a user interface is made easy to be used for person retrieval in an image monitoring system.

### BACKGROUND OF THE INVENTION

Conventionally, video surveillance systems are installed in public facilities such as hotels, buildings, convenience stores, financial agencies, dams, roads, or the like for the purpose of prevention of crimes and accidents. Such a video surveillance system picks up images of a person or the like under surveillance with an image pickup apparatus such as a camera and transmits the image to a surveillance center such as a management office and a security room. Then, a surveillance person may monitor the images and be alert on and/or record or save the images for the purpose or as required.

In many cases, a video surveillance system generally employs a random access medium such as a hard disk drive (HDD) as a recording medium for recording images, instead of a conventional video tape medium. Moreover, such a recording medium is recently increasing in capacity.

An increased capacity of a recording medium has dramatically increased the quantity of recordable images and, as a result, enables the recording medium to record more images at multiple points and images for a longer time duration. However, there arises the problem of having to visually check the recorded images.

With this background, an image surveillance system having a retrieval function for finding desired images more simply or easily is spreading. Particularly, there have recently emerged systems having more advanced retrieval functions which automatically detect a specific event in an image in real time by using an image recognition technique, records it with the image, and makes it possible to retrieve the event later. A typical one of these functions is a person retrieval function.

The person retrieval function is a function that regards an appearance of a person in video as a target of automatic detection, records it in real time, and finds the image with the person therein from among recorded images later. From a functional aspect, the person retrieval function is roughly divided into following two functions.

The first function is an appearance event retrieval function. The appearance event retrieval function is a function that simply finds out the presence or absence of an appearance (event) of a person in an image. If it is determined that there is an event (i.e., person) in an image, a retrieval result presents the number of events, the occurrence time of each event, the device number of an image pickup device that picked up the event, a picked-up image (image with a person therein) or the like, in addition to the presence or absence of the event. Also, it is often the case that, a query for this retrieval including an event occurrence time, the device number of an image pickup device, and the like is provided as information for narrowing down the range of retrieval targets. In the followings, the information for narrowing down the range of retrieval targets will be referred to as narrowing-down parameters.

The second function is a similar person retrieval function. While the aforementioned appearance event retrieval function involves a retrieval that does not specify an appearance person, this function involves finding, from among recorded images, whether or not a particular person specified by a user is picked up at a different time or by an image pickup device at a different position. If there is an image in which a particular person is shown, a retrieval result presents the number of such images, an image pickup time, the device number of an image pickup device, a picked-up image (image with a person therein), similarity to be described later and the like in addition to the presence or absence of image in which a particular person is shown.

A user can specify a particular person by specifying one image (hereinafter, referred to as a retrieval key image) in which, a person desired to be retrieved is shown. The retrieval key image may be specified from recorded images or any images from external devices. The retrieval is implemented by extracting an image feature of the person in the retrieval key image by employing an image recognition technique, comparing it with an image feature of a person in a recorded image, obtaining a similarity between them, and determining whether they are the same person or not. Extraction and recording of a feature of a person in a recorded image are performed in advance at different timings, such as during image recording. A query of this retrieval may include narrowing-down parameters in most cases.

In both of the retrieval functions, a retrieval result contains linkage information for retrieving recorded images, and the recorded images from the retrieval result can be reproduced to find the head thereof.

Japanese Patent Laid-Open Publication No. 2009-123196 discloses an image retrieval device capable of improving user convenience by specifying a retrieval key image as described above, selecting one from images of a retrieval result, displaying it on a separate display area, and using it as the next key image.

The above-described person retrieval function, in particular, the similar person retrieval function, provides an easy lead to a start part of a desired person image from an enormous amount of retrieval target images recorded in a recording device, which is very convenient.

However, the existing similar person retrieval function has a tendency that an output retrieval result may be incorrect due to a variation in the feature of a person, e.g., a variation in contour elements generated by a difference in shooting angles between respective points or the posture of the person at each time.

That is, e.g., if an image with a full face of a person is used as a retrieval key image, recorded images found as a retrieval result mostly have full faces. Similarly, if an image with an oblique face of a person is used as a retrieval key image, recorded images found as a retrieval result mostly have oblique faces at similar angles. In other words, if an image of a full face is used as a retrieval key image, there is a high possibility to fail to find an oblique face image of the same person and vice versa.

On the contrary, a different person may be actually regarded as the same person mistakenly, a retrieval result may have a low accuracy, and, as a result, the right person may be missed out.

Meanwhile, in case the similar person retrieval function is applied to a video surveillance system aiming at safety and reliability, it is required to find all images of the same person from recorded images in terms of the system characteristics.

Therefore, in order to satisfy the above-mentioned need, it becomes important to perform a retrieval multiple times while changing retrieval conditions, i.e., changing a retrieval key image and to combine multiple retrieval results obtained therefrom.

However, the existing person retrieval function has the problem that it does not provide a method for efficiently providing multiple similar person retrievals and a method for efficiently using multiple retrieval results that can be obtained by the multiple similar person retrievals.

### SUMMARY OF THE INVENTION

The present invention provides a similar image retrieval system which makes it easy to use a user interface by specifying a key image and, in the case of similar image retrieval, efficiently performing the retrieval.

The similar image retrieval system in accordance with the present invention includes, e.g., an image pickup device for picking up an image, a recording device for storing a picked-up image and retrieving it, and a terminal device for allowing a user to specify a retrieval.

The recording device retrieves an image similar to a key image specified by the user by extracting a feature of an image and evaluating the feature. There is provided means for assigning keywords, such as name, feature or the like to a result image of similar image retrieval.

For an image retrieval, there are provided two types of retrieving methods, including a similar image retrieval that excludes an image assigned with a keyword from a retrieval target and an appearance event retrieval that regards only an image assigned with a keyword as a retrieval target.

After performing multiple similar image retrievals and determining that a keyword is assigned to sufficient amount of images among retrieval target images, an appearance event retrieval is executed.

According to the configuration of the similar image retrieval system in accordance with the present invention, the person retrieval function of the video surveillance system enables it to efficiently combine retrieval results of multiple similar person retrievals and obtain them as a single retrieval result. Moreover, it is also possible to obtain the above-mentioned effect while performing multiple similar person retrievals simultaneously by using multiple terminal devices.

In accordance with the present invention, it is possible to provide a similar image retrieval system which is suitable to make a user interface easy to be used by specifying a key image and, in the case of a similar image retrieval, efficiently performing the retrieval.

### BRIEF DESCRIPTION OF THE DRAWINGS

The objects and features of the present invention will become apparent from the following description of embodiments, given in conjunction with the accompanying drawings, in which:

FIG. 1 is a system configuration view of a similar image retrieval system in accordance with one embodiment of the present invention;

FIG. 2 is a hardware configuration view of an image pickup device;

FIG. 3 is a hardware configuration view of a recording device;

FIG. 4 is a hardware configuration view of a terminal device;

FIGS. 5A and 5B are views showing a data structure used in the similar image retrieval system in accordance with one embodiment of the present invention;

FIG. 6 is a view showing a processing sequence between the recording device 102 and the terminal device 103;

FIG. 7 is a view showing a processing sequence between the recording device 102 and the terminal devices 103a and 103b;

FIG. 8A is a view showing one example of a retrieval screen in an initial state prior to executing a retrieval;

FIG. 8B is a view showing one example of a retrieval screen in a state immediately before executing a similar person retrieval;

FIG. 8C is a view showing one example of a retrieval screen in a state immediately after executing a similar person retrieval;

FIG. 8D is a view showing one example of a retrieval screen in a state immediately after executing keyword assignment;

FIG. 8E is a view showing one example of a retrieval screen in a state immediately before executing a second similar person retrieval;

FIG. 8F is a view showing one example of a retrieval screen in a state immediately after executing a second similar person retrieval;

FIG. 8G is a view showing one example of a retrieval screen in a state immediately after executing an appearance event retrieval;

FIG. 9 is a flowchart showing a recording process;

FIG. 10 is a flowchart showing an image playback process;

FIG. 11A is a flowchart showing a person retrieval process (one of two); and

FIG. 11B is a flowchart showing a person retrieval process (the other of two).

### DETAILED DESCRIPTION OF THE EMBODIMENTS

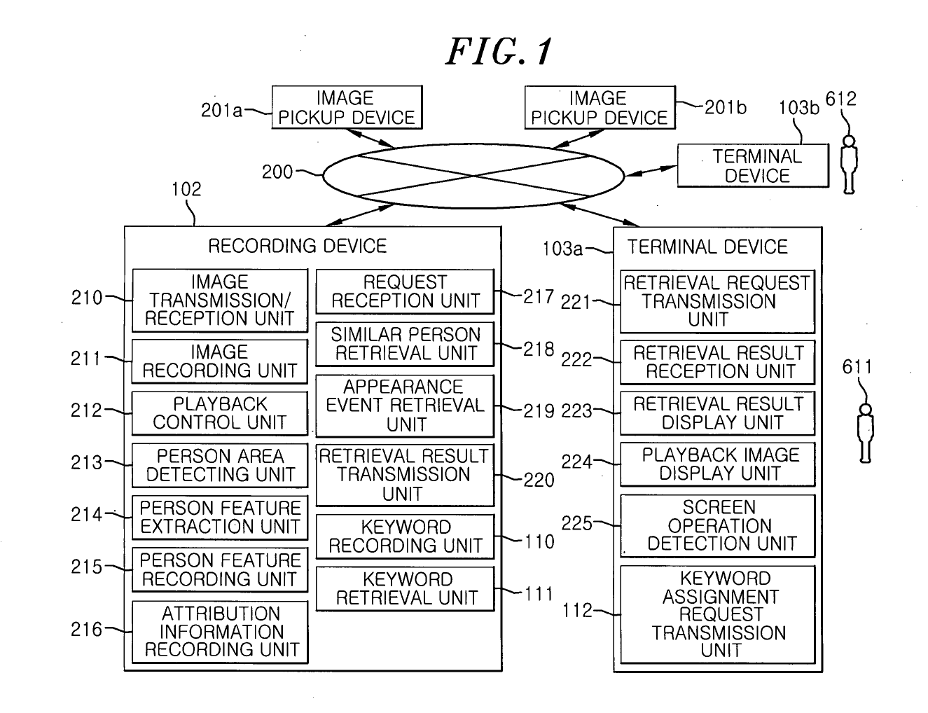

Hereinafter, an embodiment in accordance with the present invention will be described with reference to FIGS. 1 to 11B.

First, a configuration of a similar image retrieval system in accordance with the embodiment of the present invention will be described with reference to FIGS. 1 to 4.

As shown in FIG. 1, the similar image retrieval system is configured in a manner that an image pickup device 201 (201a, 201b and the like), a recording device 102, and a terminal device 103 (103a, 103b and the like) are connected to a network 200 so that they can communicate with each other.

The network 200 is communications means, such as a dedicated network, intranet, internet, wireless LAN or the like, interconnecting each device for data communications.

The image pickup device 201 is a device, such as a network camera, a surveillance camera or the like, that performs digital conversion on an image picked up by a CCD (Charged Coupled Device), a CMOS (Complementary Metal Oxide Semiconductor) element or the like and outputs the converted image data to the recording device 102 via the network 200.

The recording device 102 is, e.g., a network digital recorder or the like that records the image data inputted from the image pickup device 201 via the network 200 in a recording medium, such as a hard disk drive (HDD) or the like. Also, this device is equipped with a person retrieval function including the technique of the present invention.

The recording device 102 includes an image transmission/reception unit 210, an image recording unit 211, a playback control unit 212, a person area detection unit 213, a person feature extraction unit 214, a person feature recording unit 215, an attribute information recording unit 216, a request reception unit 217, a similar person retrieval unit 218, an appearance event retrieval unit 219, a retrieval result transmission unit 220, a keyword recording unit 110 and a keyword retrieval unit 111.

The image transmission/reception unit 210 is a processing unit for receiving and outputting an image from and to the outside of the device. The image transmission/reception unit 210 receives input image data from the image pickup device and transmits output image data to the terminal device.

The image recording unit 211 executes recording of the input image data in a recording medium and reading of the output image data from the recording medium. Upon recording, an image ID (to be described later), which serves as information when reading image data, is recorded along with the input image data.

The playback control unit 212 controls the playback of image in the terminal device.

The person area detection unit 213 performs person detection on the input image data by using an image recognition technique. It determines whether or not a person is present in the image and, if a person is present, calculates coordinates of the area of the person.

The person feature extraction unit 214 calculates a feature of the person detected by the person area detection unit 213 by using an image recognition technique. While the person feature to be calculated therein may include, e.g., a shape or EOH (Edge Orientation Histograms) of a contour of a person, skin color, gait (the way a person moves its legs like at what timing and which leg the person moves), or the shape or EOH of the contour of face characteristics of a person, or the size, shape, layout relationship or the like of the main facial components including eyes, nose, and mouth, types and numbers of features are not limited thereto in the present embodiment.

The person feature recording unit 215 executes recording and reading of the feature calculated by the person feature extraction unit 214 in and from a recording medium. The recording medium of the image data for the image recording unit 211 and the recording medium of the person feature for this processing unit may be identical to each other or different from each other.

The attribute information recording unit 216 executes recording and reading of attribute information associated with the image data in and from a recording medium. The attribute information includes, e.g., an image pickup time, a device index number of each image pickup device and the like.

The request reception unit 217 receives a retrieval request or keyword assignment request from the terminal device 103. Examples of the retrieval request include a similar image retrieval request and an appearance event retrieval request.

The similar person retrieval unit 218 performs retrieving when the request received by the request reception unit 217 is a similar person retrieval request.

The appearance event retrieval unit 219 performs retrieving when the request received by the request reception unit 217 is an appearance event request.

The retrieval result transmission unit 220 transmits a similar person retrieval result obtained from the similar person retrieval unit 218 or an appearance event retrieval result obtained from the appearance event retrieval, unit 219 to the terminal device 103.

The keyword recording unit 110 executes recording and reading of a keyword in and from a recording medium based on the keyword assignment request received by the request reception unit 217.

The keyword retrieval unit 111 performs keyword retrieval when a keyword is included in the retrieval request data received by the request reception unit 217.

The terminal device 103 may be implemented by a general personal computer (PC) having a network function or may be a dedicated retrieval terminal.

The terminal device 103 includes processing units, such as a retrieval request transmission unit 221, a retrieval result reception unit 222, a retrieval result display unit 223, a playback image display unit 224, a screen operation detection unit 225 and a keyword assignment request transmission unit 112. Also, this device is equipped with a person retrieval function for implementing the technique of the present invention.

The retrieval request transmission unit 221 transmits a retrieval request to the recording device 102. In a case of the similar person retrieval, a retrieval key image is included in retrieval request data. Further, the retrieval request data may include narrowing-down parameters.

The retrieval result reception unit 222 receives a retrieval result from the recording device 102. Data received as the retrieval result includes a set of images that can be obtained by performing a similar person retrieval or appearance event retrieval in the recording device 102. Each of the images in the set is created by performing a downscaling of an image from images recorded in the recording device 102. Now, each image will be referred to as a ‘retrieval result image’ and data transmitted and received as the retrieval result will be referred to as ‘retrieval result data’.

The retrieval result display unit 223 displays a retrieval result received by the retrieval result reception unit 222 on the screen. An example of the screen displayed will be described later.

The playback image display unit 224 displays, on the screen, successive moving images in the input image data inputted from the recording device 102.

The screen operation detection unit 225 detects and acquires operations by the user.

The keyword assignment request transmission unit 112 transmits a keyword assignment request to the recording device 102.

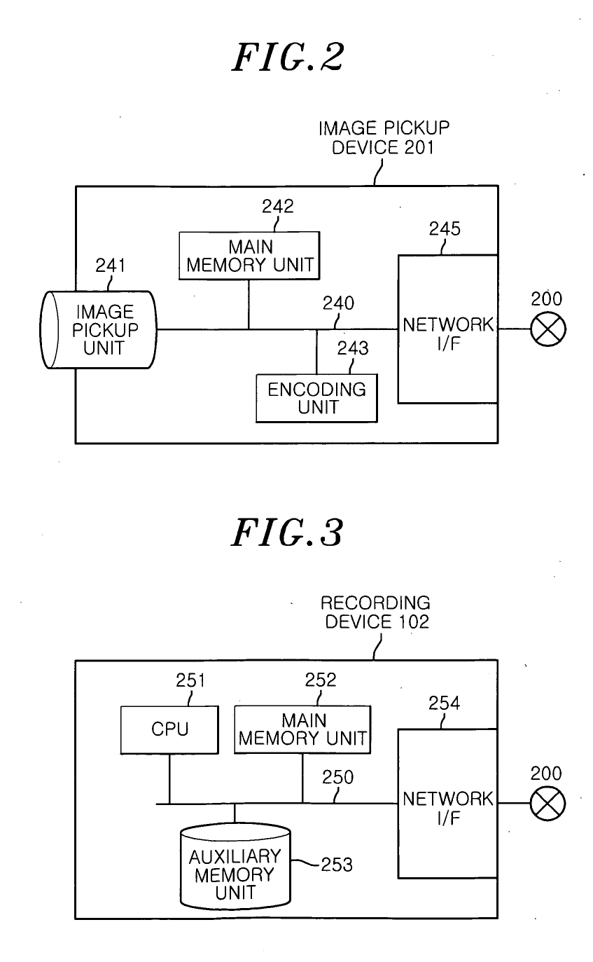

As shown in FIG. 2, the image pickup device 201 includes an image pickup unit 241, a main memory unit 242, an encoding unit 243 and a network I/F (Interface) 245 which are linked by a bus 240.

The image pickup unit 241 converts an optical signal picked up by a lens into digital data. The encoding unit 243 encodes the digital data outputted from the image pickup unit 241 to convert it into image data such as JPEG, MPEG or the like. The main, memory unit 242 stores the picked-up digital data and the encoded image data. The network I/F 245 is an interface for transmitting the image data in the main memory unit 242 to the recording device 102 via the network 200.

As shown in FIG. 3, the recording device 102 includes a CPU 251, a main memory unit 252, an auxiliary memory unit 253 and a network I/F 254 which are linked by a bus 250.

The CPU 251 executes a program for controlling each component of the recording device 102 and implementing the functions thereof. The main memory unit 252 is an intermediate memory that is implemented by a semiconductor device, such as a DRAM (Dynamic Random Access Memory), and loads and stores image data for retrieving and the program executed by the CPU 251. The auxiliary memory unit 253 is a memory that is implemented by an HDD or a flash memory and has a larger capacity than that of the main memory unit 252 and stores image data or a program. The network I/F 254 is an interface for receiving image data from the image pickup device 201 via the network 200, receiving a retrieval keyword from the terminal device 103, or transmitting image data to the terminal device 103.

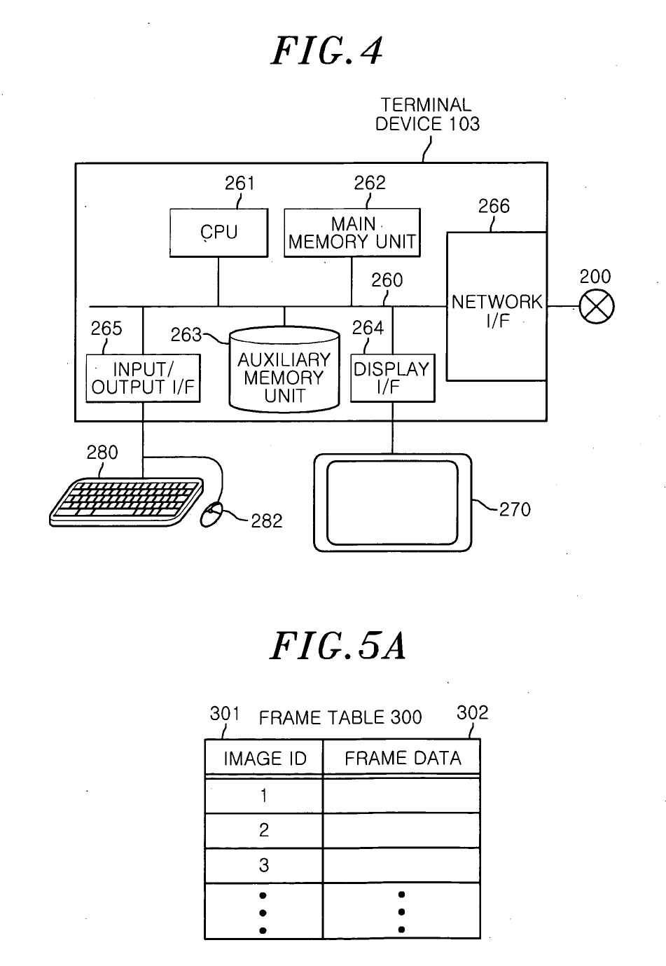

As shown in FIG. 4, the terminal device 103 includes a CPU 261, a main memory unit 262, an auxiliary memory unit 263, a display I/F 264, an input/output I/F 265 and a network I/F 266 which are linked by a bus 260.

The CPU 261 executes a program for controlling each component of the terminal device 103 and implementing the functions thereof. The main memory unit 262 is an intermediate memory that is implemented by a semiconductor device, such as a DRAM and loads and stores image data for displaying and a program executed by the CPU 261. The auxiliary memory unit 263 is a memory that is implemented by an HDD or a flash memory and has a larger capacity than that of the main memory unit 262 and stores a retrieval keyword, image data and a program. The display I/F 264 is an interface for connecting the terminal device 103 to a display device 270. The input/output I/F 265 is an interface for connecting the terminal device 103 to an input/output device, such as a keyboard 280 and a mouse 282. The network I/F 266 is an interface for, transmitting a retrieval keyword to the recording device 102, or receiving the image data from the recording device 102 via the network 200. The display device 270 is a device, such as an LCD (Liquid Crystal Display), for displaying a still image or a moving image thereon.

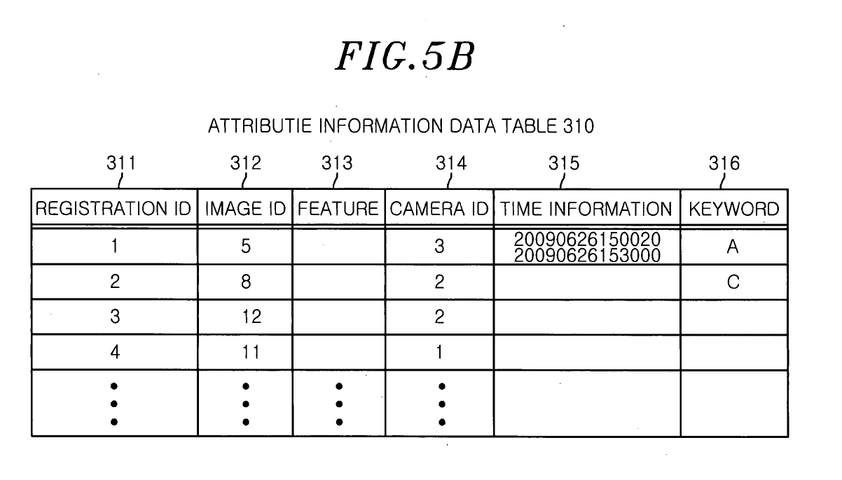

Next, a data structure used in the similar image retrieval system in accordance with the embodiment of the present invention will be described with reference to FIGS. 5A and 5B.

The data structure used in the similar image retrieval system includes a frame table 300 as shown in FIG. 5A and an attribute information table 310 as shown in FIG. 5B.

The frame table 300 is a table for storing image data, which has an image ID 301 and frame data 302, e.g., JPEG corresponding to the image ID 301.

The attribute information table 310 is a table for storing attribute information of an image, which is a result of analysis of image data. The attribute information table 310 includes a registration ID 311 for identifying each of attribute information. A Part of frames stored in the frame table 300 is specified by the image ID 312 and a feature of an image of each frame, an ID of the image pickup device 201 that has picked up the image, information about the time at which the image of the corresponding frame was captured and a keyword assigned to the frame are stored in a feature field 313, a camera ID field 314, a time information field 315 and a keyword field 316, respectively.

Also, when the frame rate of recording is 30 fps (frames per second), for example, an image in which a person is present becomes a target to be analyzed. The image is captured and analyzed with a maximum frame rate of 3 about fps.

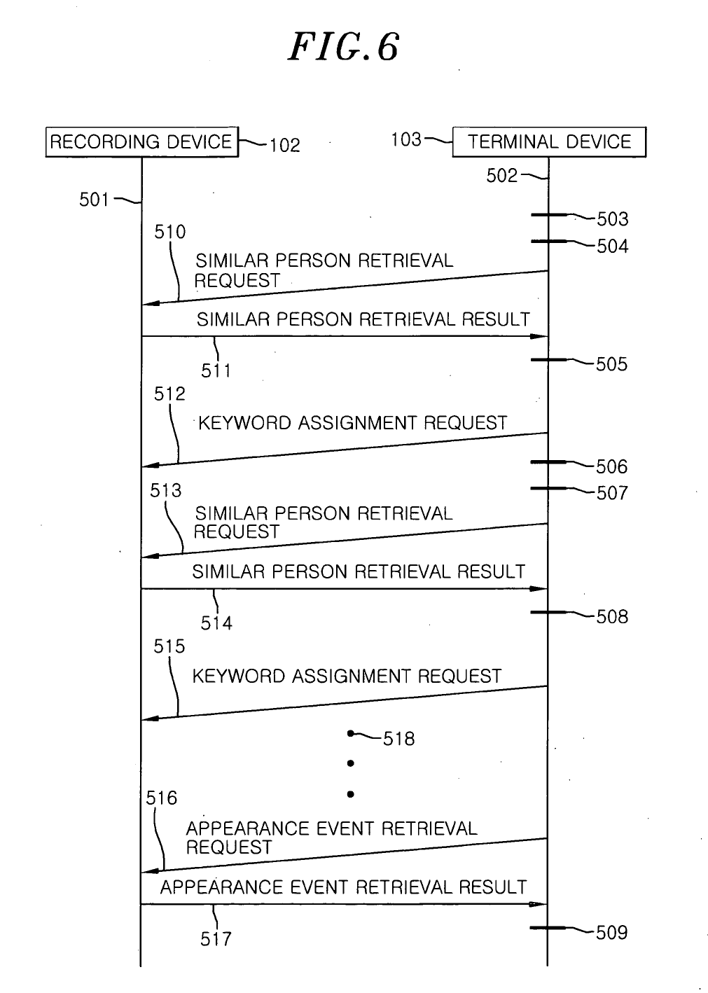

Next, a processing sequence between the recording device 102 and the terminal device 103 will be described with reference to FIG. 6.

Axes 501 and 502 shown in FIG. 6 denote the time lines representing time flows in the recording device 102 and the terminal device 103 from top to bottom. Each of timings 503 to 509 denotes timing at the time line. One example of a screen displayed on the terminal device 103 at each timing and one example of a user operation will be described later.

Communications 510 to 517 denote main communications between the recording device 102 and the terminal device 103.

The communication 510 and the communication 511 respectively correspond to a request and a response. The communication 510 involves a similar person retrieval request and the communication 511 involves a similar person retrieval result, through which one similar person retrieval is performed. The same applies for the communications 513 and 514. The communication 512 involves a keyword assignment request for an image. The same applies for the communication 515. The communications 516 and 517 respectively correspond to a request and a response and the communication 516 involves an appearance event retrieval request and the communication 517 involves an appearance event retrieval result, through which one appearance event retrieval is performed. As denoted with a recursive symbol 518 shown in FIG. 6, the similar person retrieval request, the similar person retrieval result and the keyword assignment request are repeated an appropriate number of times.

As described above, the similar retrieval method of the present invention involves a sequence in which a pair of a similar person retrieval and keyword assignment is repetitively carried out and an appearance event retrieval is carried out at the end.

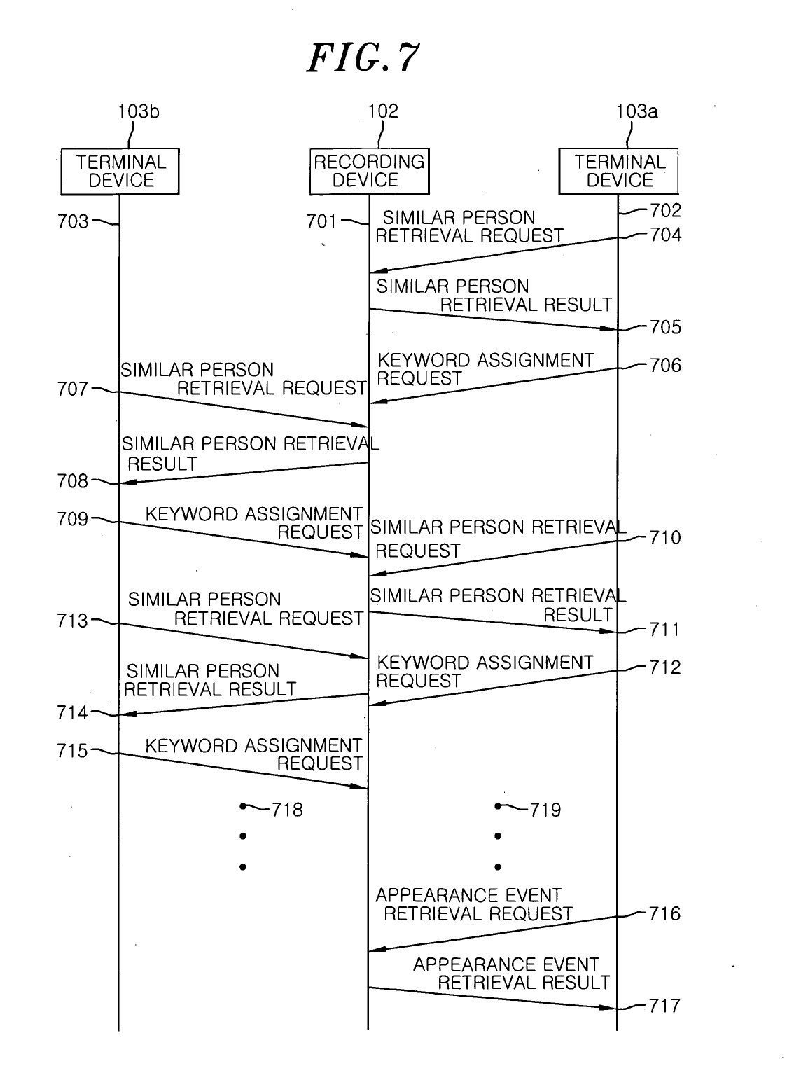

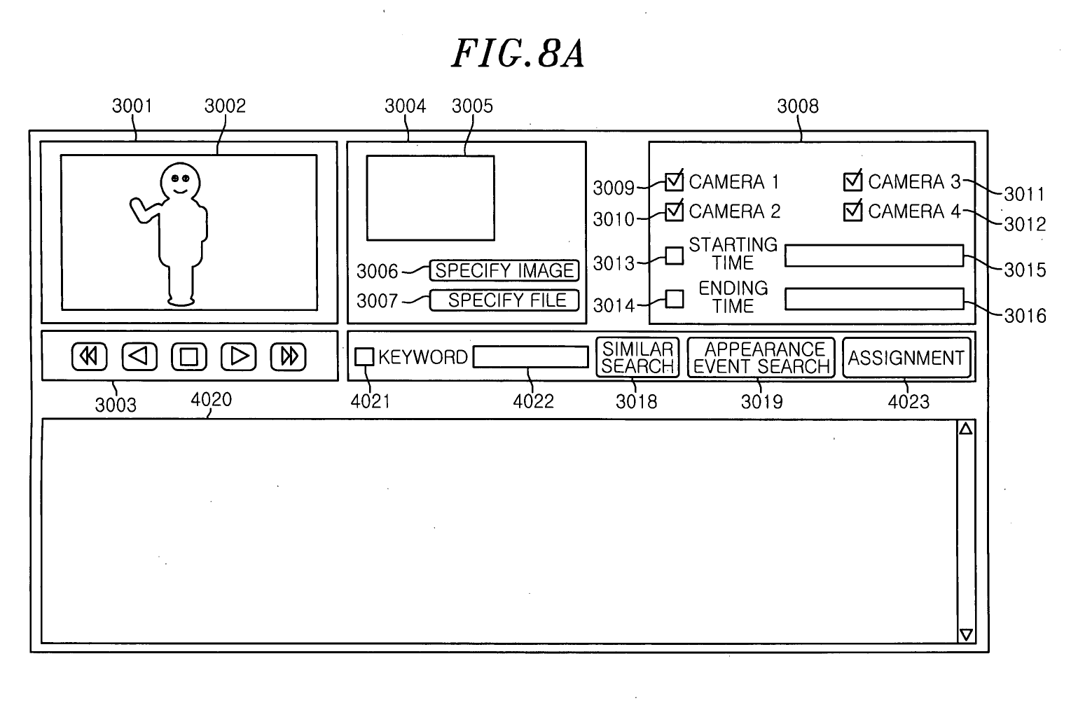

Next, a processing sequence between the recording device 102 and the terminal devices 103a and 103b when there are multiple terminals devices in the similar image retrieval system will be described with reference to FIG. 7.

Axes 701, 702 and 703 denote time lines that represent time flows in the recording device 102 and the terminal devices 103a and 103b from top to bottom.

Communications 704 to 717 denote main communications between the recording device 102 and the terminal devices 103a and 103b. They are similar to the communications 510 to 517 shown in FIG. 6.

Recursive symbols 718 and 719 denote repeating communications an appropriate number of times.

First of all, when a user 611 (see, FIG. 1) operates the terminal device 103a to execute a similar person retrieval on a certain person, e.g., ‘A’, a request for the similar person retrieval is transmitted to the recording device 102 (i.e., communication 704) and a retrieval result obtained in the recording device 102 is provided to the user operating the terminal device 103a (i.e., communication 705). When the retrieval result includes a correct image, the user operating the terminal device 103a enters a keyword ‘A’ through the keyboard 280 to request an assignment of the keyword ‘A’ to the correct image included in the communication 705 via communication 706.

At the next timing, when another user 612 (see, FIG. 1) operates the terminal device 103b to execute a similar person retrieval on the person ‘A’ by using the terminal device 103b in the same way, a retrieval result is provided to the user operating the terminal device 103b through communications 707 and 708. When the retrieval result includes a correct image, the user 612 operating the terminal device 103b enters a keyword ‘A’ in the same way to assign the keyword ‘A’ to the correct image included in the communication 708 via the communication 709. However, the correct image to which the keyword has already been assigned via the communication 706 is not included in the retrieval result included in the communication 708. That is, an image which has been assigned with a keyword is not present in the next retrieval result.

At the next timing, when the user 611 operates the terminal device 103a to execute a similar person retrieval on the person ‘A’ with the terminal device 103a in the same way, a retrieval result is provided to the user 611 through communications 710 and 711. When the retrieval result includes a correct image, the user 611 enters a keyword ‘A’ in the same way to assign the keyword ‘A’ to the correct image included in the communication 711 via the communication 712. However, the correct images to which the keyword has been assigned in the communication 706 or 708 are not included in retrieval result included in the communication 711.

In this way, an operation, i.e., keyword assignment on the retrieval result of one terminal device is reflected to the retrieval result of another terminal device, thus enabling mutually good efficient retrieval.

So far, the present invention has been described with respect to an example in which the user 611 operating the terminal device 103a and the user 612 operating the terminal device 103b perform operations in a completely alternate way. However, for instance, if the user 612 operating the terminal device 103b likewise executes a similar person retrieval on the person ‘A’ with the terminal device 103b before communication 712, a retrieval result is provided to the user 612 through communications 713 and 714. Since the communication 714 is performed at an earlier timing than that of communication 712 by the user 611 operating the terminal device 103a, there is a possibility that retrieval result included in the communication 714 may have a same correct image included in the retrieval result provided to the user 611 operating the terminal device 103a through communication 711.

Even when the same correct image is included in the retrieval result included in the communication 714 and in the retrieval result included in the communication 711, if a keyword has already been assigned to the correct image through the communication 712 by the user 611 operating the terminal 103a, the user 612 operating the terminal device 103b can assign a keyword to the same correct image included in the communication 714 to overwrite the keyword thereon through communication 715, and vice versa. Then, no error or problem occurs in the subsequent retrieval.

Finally, when the user 611 operating the terminal device 103a executes an appearance event retrieval by the keyword ‘A’ by using the terminal device 103a, results of the similar person retrieval carried out by the two users 611 and 612 respectively operating the terminal device 103a and the terminal device 103b are provided to the user 611 at a time through communications 716 and 717.

In this way, in the similar image retrieval system in accordance with the present embodiment, the similar person retrieval can be performed asynchronously on the recording device by using multiple terminal devices, which can then be aggregated at the end to acquire the results.

This system is highly effective when it is applied to a case in which, e.g., an image with a particular person is repetitively retrieved in a conventional recording device.

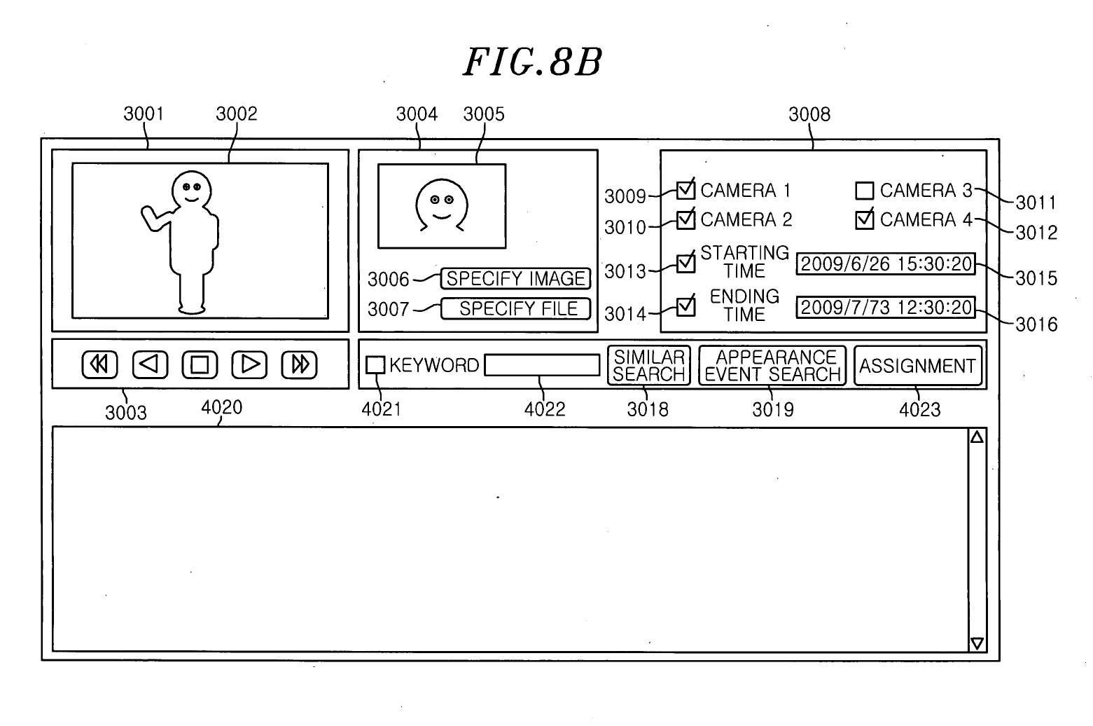

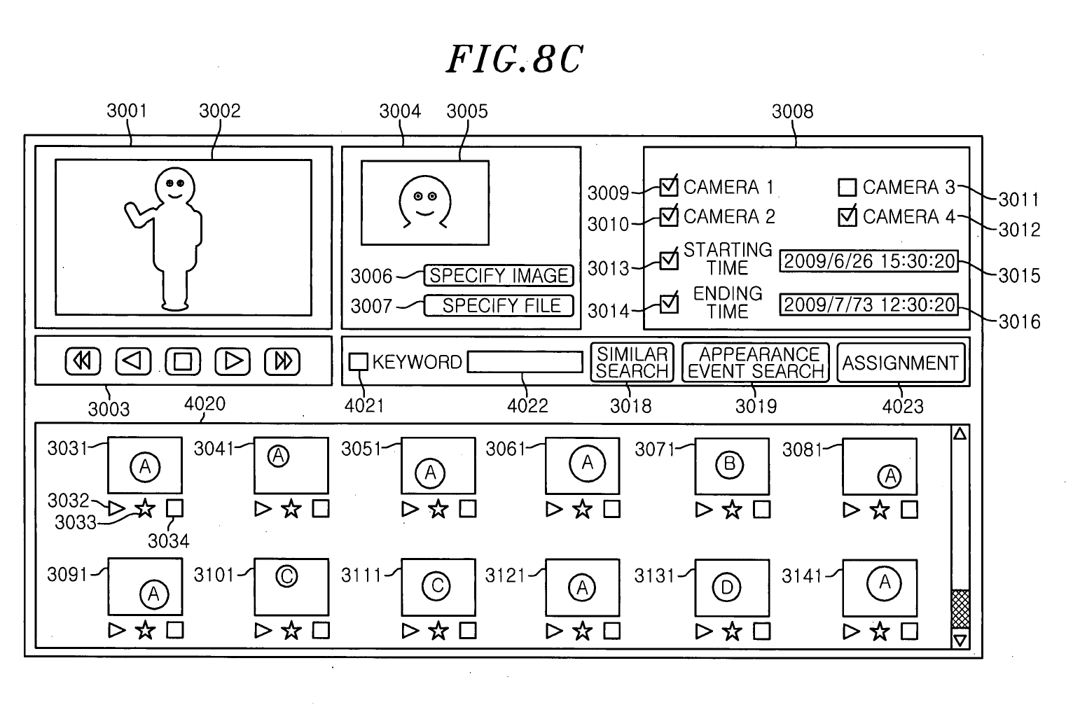

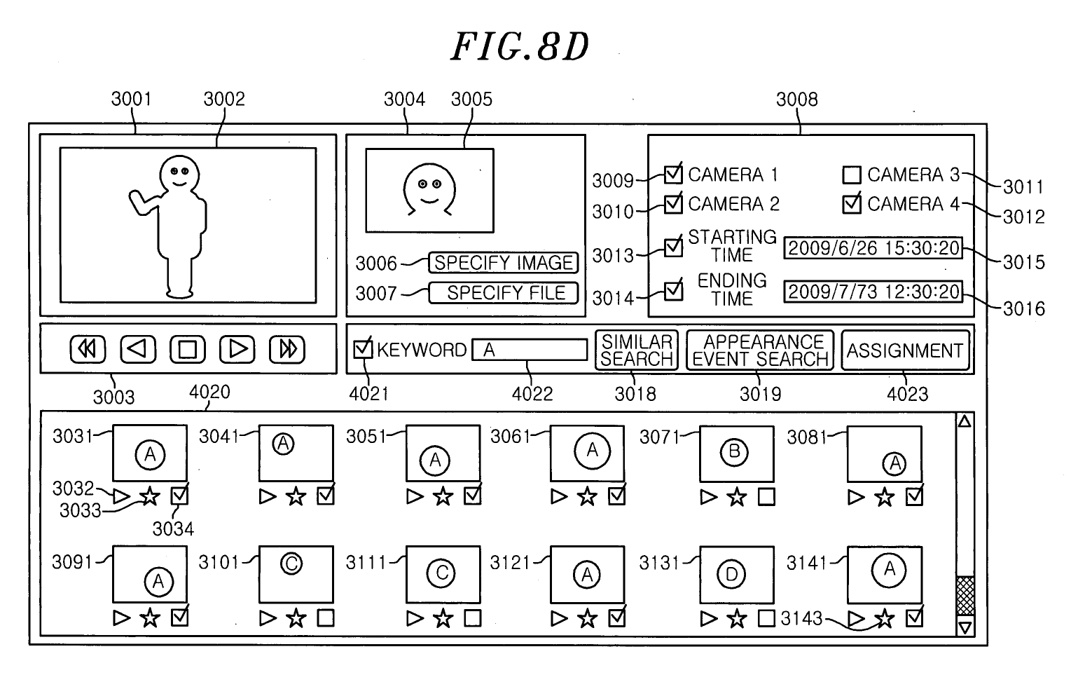

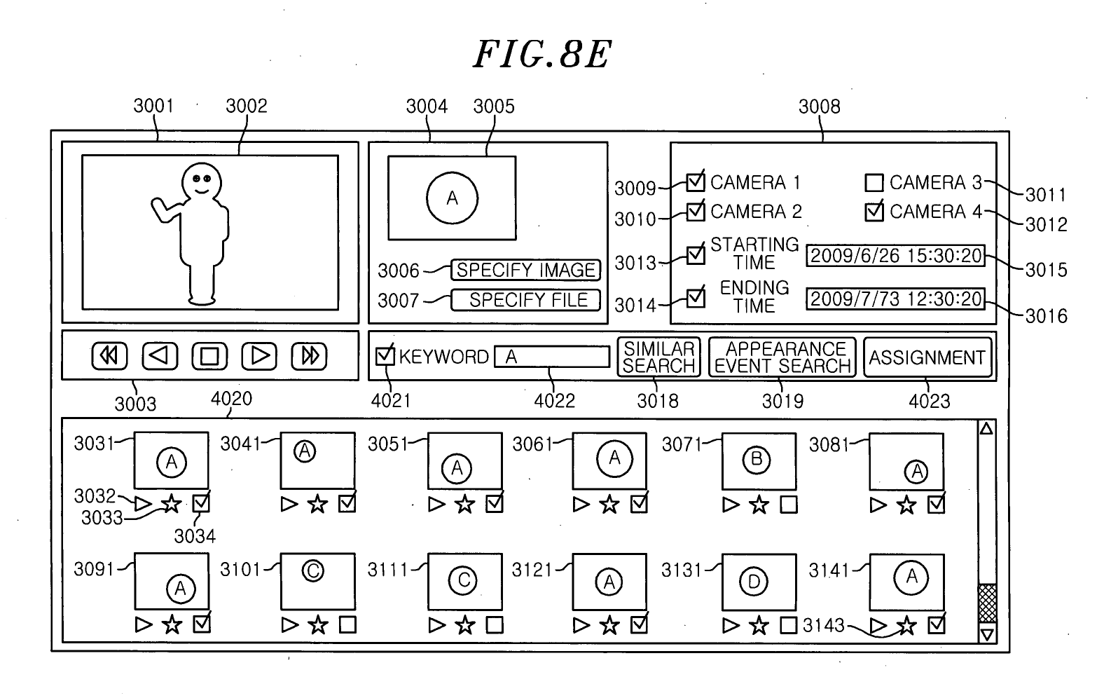

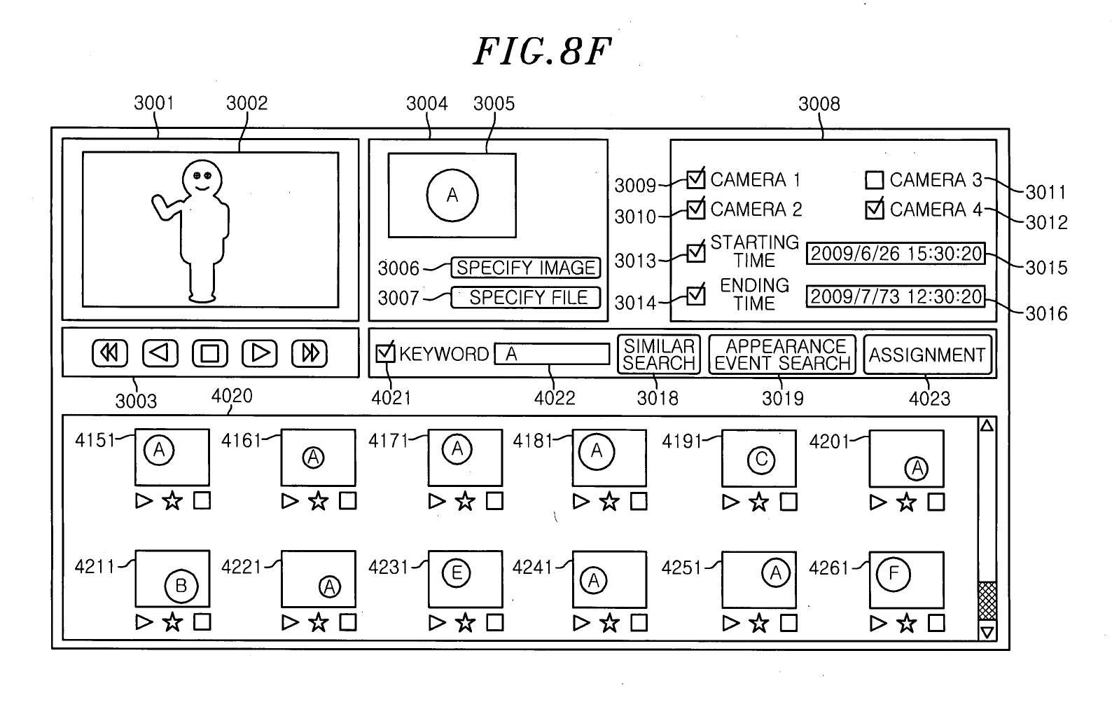

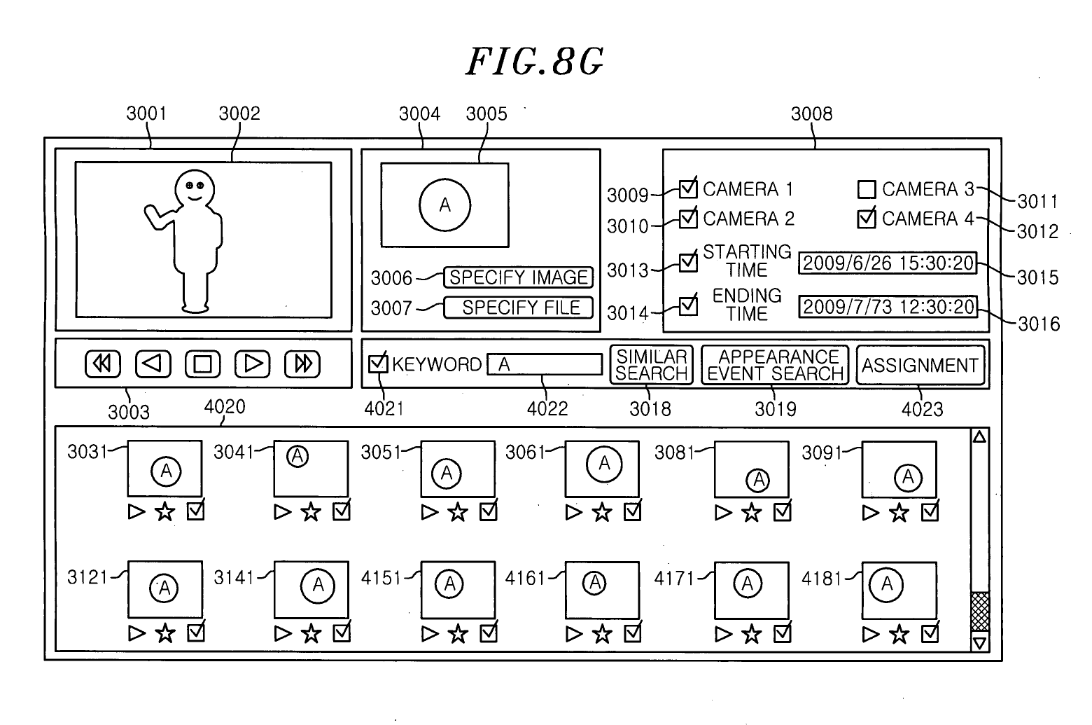

Next, user's operations on the terminal device 103 in the similar image retrieval system of the present invention will be described with reference to FIGS. 8A to 8G.

Each of FIGS. 8A to 8G shows a screen of a phase during the similar image retrieval displayed on the display device 270 of the terminal device 103.

FIG. 8A shows one example of a retrieval screen in an initial state before executing retrieval, i.e., in the terminal device 103, e.g., at the timing 503 in FIG. 6. The user starts retrieval from this screen.

The retrieval screen includes a playback image display area 3001, an image playback operation area 3003, a key image specifying area 3004, a narrowing-down retrieval parameter specifying area 3008, a retrieval execution area 4017 and a retrieval result display area 4020.

The playback image display area 3001 is an area for continuously displaying images recorded in the recording device 102 as a moving image 3002. The moving image 3002 is displayed on the play back image display area 3001 with images recorded in the recording device 102.

The image playback operation area 3003 is an area for operating the playback of the images recorded on the recording device 102.

To each of the buttons in this area, there is allocated its unique playback type. In this drawing, e.g., playback types of rewind, reverse, stop, play and fast forward are sequentially allocated to the buttons starting from the left. As each button is properly pressed, the operation on the moving image 3002 is correspondingly switched to the playback type allocated to the button.

The key image specifying area 3004 is an area for specifying and displaying a retrieval key image.

This area has a retrieval key image 3005, an image specifying button 3006 and a file specifying button 3007.

The retrieval key image 3005 is an image used as a key for similar image retrieval. In an initial state, the retrieval key image is not specified yet, and hence the key image cannot be displayed. Optionally, a prepared image representing an unspecified state may be displayed, or an indication of unspecified state may be provided.

The image specifying button 3006 is a button for specifying an image displayed on the playback image display area 3001 as a retrieval key image upon pressing the button 3006.

The file specifying button 3007 is a button for specifying other images than the images recorded in the recording device 102, e.g., an image taken by a digital still camera or an image captured by a scanner, as a retrieval key image. Upon pressing this button, a dialog box specifying files of these images is displayed so that the user can specify a desired image file therein.

The narrowing-down parameter specifying area 3008 is an area for specifying the type and value (range) of a narrowing-down parameter for the image retrieval. This area has image pickup device specifying checkboxes 3009, 3010, 3011 and 3012, time specifying checkboxes 3013 and 3014 and time specifying fields 3015 and 3016.

The image pickup device specifying checkboxes 3009, 3010, 3011 and 3012 are buttons for specifying an image pickup device 201 from which the image is to be retrieved. When pressed, displayed on each of the buttons is a checkmark indicative of its selection. This mark is disabled when the button is pressed again and is alternately enabled and disabled when repeatedly pressing the button.

In an initial state, all the image pickup devices 201 are targeted for retrieval, so all the image pickup device checkboxes are selected or checked.

The time specifying checkboxes 3013 and 3014 are buttons for specifying a time range to be retrieved when the image being retrieved. The same display format as the checkboxes 3009, 3010, 3011 and 3012 applies for these buttons. When the time specifying check box 3013 is selected, a starting time is allocated to the time range. When the time specifying checkbox 3013 is not selected, no starting time is defined for the time range, which means that a retrieval target range includes the earliest image recorded in the recording device 102.

In a similar way, when the time specifying check box 3014 is selected, an ending time is allocated to the time range. When the time specifying checkbox 3014 is not selected, no ending time is defined for the time range, which means that a retrieval target range includes the latest image recorded in the recording device 102.

The time specifying fields 3015 and 3016 are input fields for specifying values of the aforementioned starting time and ending time.

In an initial state, all time zones are targeted for retrieval, so all the time specifying checkboxes 3013 and 3014 are not checked and the time specifying fields 3015 and 3016 are empty.

The retrieval execution area 4017 is an area for instructing image retrieval execution. This area includes a keyword specifying checkbox 4021, a keyword specifying field 4022 and a keyword assignment button 4023, in addition to a similar person retrieval button 3018 and an appearance event retrieval button 3019.

The similar person retrieval button 3018 is a button for instructing execution of similar person retrieval by using the retrieval key image 3005. If parameters are specified in the narrowing-down parameter specifying area 3008, this button instructs execution of the similar person retrieval based on the specified parameters.

The appearance event retrieval button 3019 is a button for instructing execution of the appearance event retrieval.

If the parameters are specified in the narrowing-down parameter specifying area 3008, this button instructs execution of the appearance event retrieval based on the specified parameters.

The keyword specifying checkbox 4021 is a button for specifying a valid or invalid state for the keyword specifying field 4022. The same display format of the image pickup device specifying checkboxes 3009 to 3012 applies for this button.

The keyword specifying field 4022 is an input field for specifying a value of a keyword.

The keyword assignment button 4023 is a′button for instructing the assignment of a keyword inputted in the keyword assignment field 4022.

In an initial state, the keyword specifying checkbox 4021 is not checked, and the keyword specifying field 4022 is empty.

The function of the keyword and a relationship between the similar person retrieval button 3018 or the appearance event retrieval button 3019 and the keyword will be described later.

The retrieval result display area 4020 is an area for displaying a retrieval result. The display of the retrieval result is carried out by displaying retrieval result images in a list. In an initial state, nothing is displayed in the retrieval result display area 4020.

The user presses the image specifying button 3006, presses the image pickup device specifying checkboxes 3009, 3010 and 3012, presses the time specifying check boxes 3013 and 3014, and then enters ‘2009/6/26 15:30:20’ and ‘2009/7/13 12:30:20’ in the time specifying fields 3015 and 3016, respectively.

By this operation, the retrieval screen is transited to a state immediately before executing a similar person retrieval, i.e., the state in the terminal device 103, e.g., at the timing 504 in FIG. 6. FIG. 8B shows one example of the retrieval screen in this state.

The person ‘A’ present on the moving image 3002 is displayed, as the retrieval key image 3005, three cameras of ‘camera 1, camera 2 and camera 4’ are specified as the image pickup devices 201 desired to be retrieved and a time period from ‘2009/6/26 15:30:20’ to ‘2009/7/13 12:30:20’ is specified as a time range desired to be retrieved.

Here, the user presses the similar person retrieval button 3018. Then, the retrieval screen is transited to a state immediately after executing the similar person retrieval, i.e., the state in the terminal device 103 at the timing 505 in FIG. 6. FIG. 8C shows one example of the retrieval screen in this state.

The retrieval result display area 4020 displays a retrieval result that is obtained by executing the similar person retrieval by using the retrieval key image 3005 as a key. The display of the retrieval result is carried out by displaying retrieval result images in a list.

Retrieval result images 3031 to 3141 are displayed from the top left to the right and then on the second row from left to right in a similar order to the retrieval key image 3005. In this display example, it can be seen that the retrieval result image 3031 has the greatest similarity to the retrieval key image 3005 and the retrieval result image 3141 has the least similarity thereto.

Shown here are the retrieval results of a retrieval request for ‘images picked-up by camera 1, camera 2 and camera 4 in the time range from 2009/6/26 15:30:20 to 2009/7/13 12:30:20, which are similar to the person A’.

In the example shown in this drawing, an alphabet character in a circle shown on each of the retrieval result images represent a simplified display of the face and name of person ‘A’. For instance, the retrieval result image 3031 shows the appearance of the person ‘A’. Of course, in the actual display of the system, actual images are displayed instead of the simplified displays.

A play button 3032 for instructing the start of a continuous moving image starting from the retrieval result image, a key image specifying button 3033 and a keyword target checkbox 3034 are provided in the vicinity of the retrieval result image 3031. The other retrieval result images are also provided with play buttons, key image specifying buttons and the keyword target checkboxes, respectively.

The play button 3032 is a button for instructing the start of playback of a continuous moving image starting from the retrieval result image. For instance, when the play button 3032 is pressed, playback of continuous moving image starting with the retrieval result image 3031 is displayed as the moving image 3002, so that the user can view the moving image starting from the retrieval result image.

The key image specifying button 3033 is a button for specifying the retrieval result image 3031 as the retrieval key image 3005. For instance, when the key image specifying button 3033 is pressed, the retrieval result image 3031 is displayed as the retrieval key image 3005. Thus, a re-retrieval using the retrieval result image 3031 can be carried out.

The keyword target checkbox is a button for specifying a retrieval result image to which a keyword is to be assigned. The same display format as the other checkboxes applies to this button. For instance, when the keyword target checkbox 3034 is pressed, a check mark is displayed, and the retrieval result image 3031 becomes a keyword assignment target.

In a state immediately after executing the similar person retrieval, all the keyword target checkboxes are not checked.

Although not shown in this example, attribute information, such as image pickup time and the device index number of image pickup device which took the corresponding image, may be displayed in the vicinity of each retrieval result image or on the retrieval result image. Also, in case where multiple people are present on one retrieval result image, a person responsible to be displayed as a retrieval result may be distinguished by an additional mark such as a frame.

The example shown in this drawing depicts retrieval results obtained when executing the similar person retrieval, aimed at the person ‘A’. Thus, it can be seen that the retrieval result images 3031, 3041, 3051, 3061, 3081, 3091, 3121 and 3141 are correct images, and retrieval result images 3071, 3101, 3111 and 3131 are incorrect images.

Here, the user presses the keyword target checkboxes corresponding to the correct retrieval result images 3031, 3041, 3051, 3061, 3081, 3091, 3121 and 3141. For instance, for the retrieval result image 3031, the corresponding keyword target checkbox 3034 is pressed.

Then, the keyword specifying checkbox 4021 is pressed, ‘A’ is entered in the keyword specifying field 4022 and then the keyword assignment button 4023 is pressed. By this operation, the retrieval screen is transited to a state immediately after executing the assignment request of a keyword, the state in the terminal device 103 at the timing 506 in FIG. 6. FIG. 8D shows one example of the retrieval screen in this state.

The assigned keyword is ‘A’ and a given retrieval result image is displayed, with the corresponding keyword target checkbox being checked.

In this way, when the keyword specifying checkbox 4021 is selected, if the keyword assignment button 4023 is pressed, a keyword inputted in the keyword specifying field 4022 is assigned to the retrieval result image whose keyword target checkbox is selected.

Here, the user presses the key image specifying button 3143. Then, the screen is transited to a state immediately before executing a second similar person retrieval, i.e., the state in the terminal device 103 at the timing 507 in FIG. 6.

Here, it is assumed that the user intends to carry out one more similar person retrieval for the person ‘A’. The second retrieval is carried out in order to find an image with the person ‘A’ appeared therein that has not been found in the first retrieval. FIG. 8E shows one example of the retrieval screen in a state immediately before executing the second similar person retrieval.

As the retrieval key image 3005, the retrieval result image 3141, i.e., a second retrieval key image is displayed in key image specifying area 3004 among the correct retrieval result images obtained in the first retrieval.

It is desirable that the narrowing-down parameters are the same as in the first retrieval, so no operation is performed on the narrowing-down parameter specifying area 3008.

Here, the user presses the similar person retrieval button 3018 again. Then, the screen is transited to a state immediately after executing the second similar person retrieval, i.e., the state in the terminal device 103 at the timing 508 in FIG. 6. FIG. 8F shows one example of the retrieval screen in this state.

Like in the first retrieval, retrieval results obtained by executing the second similar person retrieval by using the retrieval key image 3005 are displayed on the retrieval result display area 4020. Retrieval result images 4151 to 4261 are displayed from the top left to the right and then on the second row from left to right in the similar order to the retrieval key image 3005.

However, the second retrieval result is different from the first retrieval result in that here are shown results of retrieving only ‘images picked-up by camera 1, camera 2 and camera 4 in a time range from 2009/6/26 15:30:20 to 2009/7/13 12:30:20, which are similar to the person A’ but are not already assigned the keyword ‘A’ thereto. That is, the correct images in the first retrieval are not included in the second retrieval result images.

In this way, when the keyword target checkbox 4021 is selected, if the similar person retrieval button 3018 is pressed, the similar person retrieval is executed on the images except the images to which the keyword specified in the keyword specifying field 4022 has been assigned.

Same as in the retrieval results obtained in the first retrieval, retrieval results for the second retrieval also include both correct images and incorrect images. In FIG. 8F, it can be seen that the retrieval result images 4151, 4161, 4171, 4181, 4201, 4221, 4241 and 4251 are correct images and retrieval result images 4191, 4211, 4231 and 4261 are incorrect images.

Here, keyword assignment is executed on the retrieval result images 4151, 4161, 4171, 4181, 4201, 4221, 4241 and 4251, which are the correct images, in the order described in FIGS. 8C to 8D.

As illustrated in the timing chart in FIG. 6, the user repeats the similar person retrieval and keyword assignment. Completion of the repetition is determined by the user based on the purpose of similar retrieval and how to use it. The ratio of correct images included in the retrieval result images may be helpful for the user to make the decision on the time of completion of the repetition.

After repeating the similar person retrieval and keyword assignment in the above-described way, the user presses the appearance event retrieval button 3019.

FIG. 8G shows one example of the retrieval screen in a state immediately after executing the appearance event retrieval, i.e., the state in the terminal device 103 at the timing 509 in FIG. 6.

The retrieval result display area 4020 displays a retrieval result obtained by executing the appearance event retrieval. The display of the retrieval result is carried out by displaying retrieval result images in a list.

Retrieval result images 3031, 3041, 3051, 3061, 3081, 3091, 3121, 3141, 4151, 4161, 4171 and 4181 are displayed from the top left to the right and then on the second row from left to right, e.g., in the order of keyword assignment or in the order of pickup time. Out of the range shown, there are retrieval result images 4201, 4221, 4241 and 4251, which the user can see by operation with a scroll bar.

Shown here are retrieval results of a retrieval request for ‘images of camera 1, camera 2, and camera 4 taken from 2009/6/26 15:30:20 to 2009/7/13 12:30:20, which are assigned the keyword A’.

In this way, when the keyword target checkbox 4021 is selected, if the appearance event retrieval button 3019 is pressed, the appearance event retrieval is executed on the images to which the keyword inputted in the keyword specifying field 4022 is assigned.

Further, when the keyword target checkbox 4021 is not selected, if the appearance event retrieval button 3019 is pressed, the appearance event retrieval is executed on images corresponding conditions of the retrieval parameters specified in the narrowing-down parameter specifying area 3008.

The retrieval result images 3031, 3041, 3051, 3061, 3081, 3091, 3121 and 3141 are correct images obtained in the first similar person retrieval, and the retrieval results 4151, 4161, 4171, 4181, 4201, 4221, 4241 and 4251 are correct images obtained in the second similar person retrieval.

Thus, the retrieval result images obtained in these retrievals are all correct images of the person ‘A’. It can be said that these images are made available by assigning the keyword to the results of the multiple similar person retrievals and combining them.

Also, the retrieval result images obtained in the appearance event retrieval are displayed with keyword target checkboxes, to which check marks are added. If the user changes its mind and wants to avoid keyword assignment for the retrieval result images, the keyword target checkboxes are pressed again to delete the check marks.

As such, a keyword is specified to retrieve images having no keyword assigned thereto in the similar retrieval, and a keyword is specified to retrieve images having a keyword assigned thereto in the appearance event retrieval, thereby efficiently retrieving similar images and, furthermore, improving the accuracy of retrieval. In an example employed in this embodiment, a keyword of ‘A’ can be assigned to a large number of images by a small number of times of similar retrievals and then images having the keyword of ‘A’ assigned thereto can be displayed all at once by the appearance event retrieval.

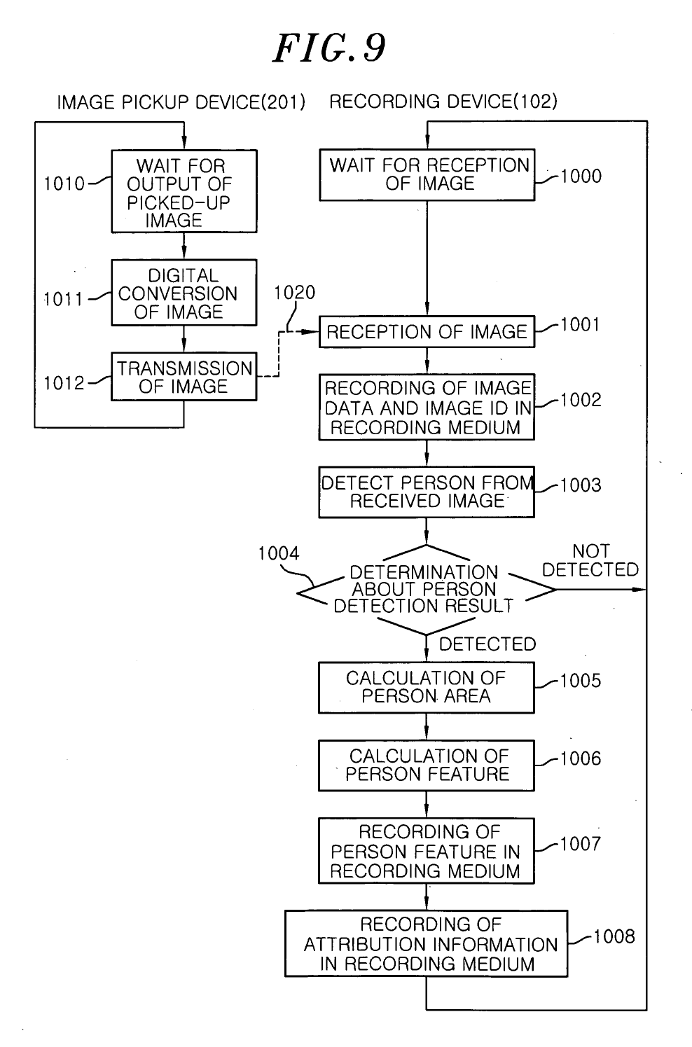

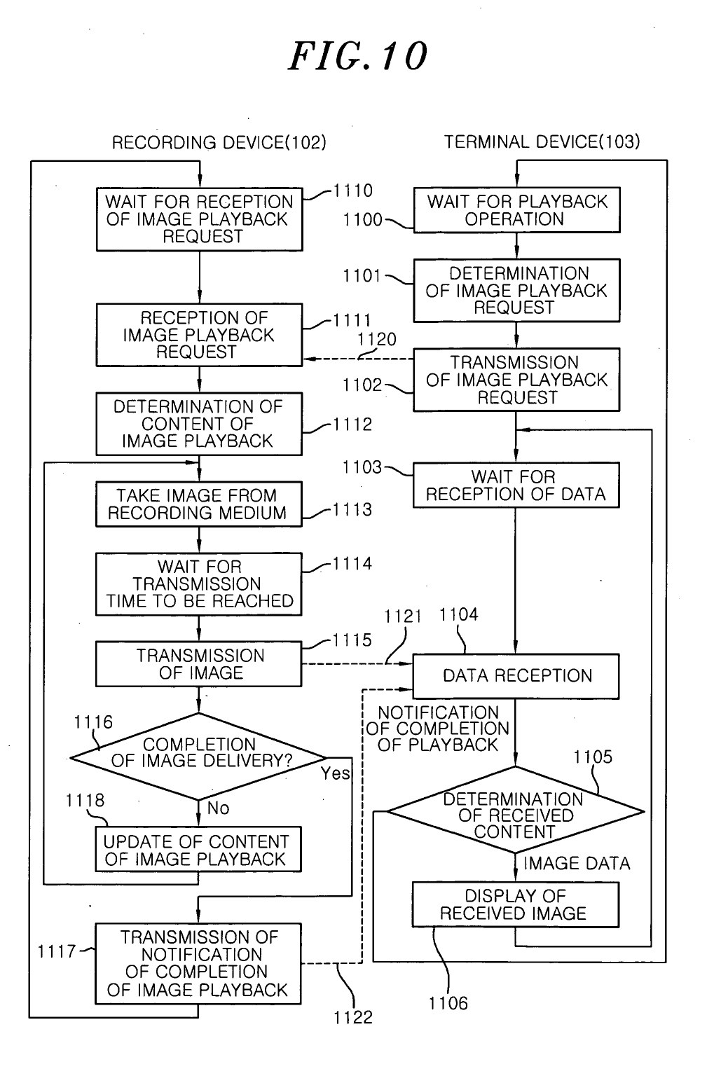

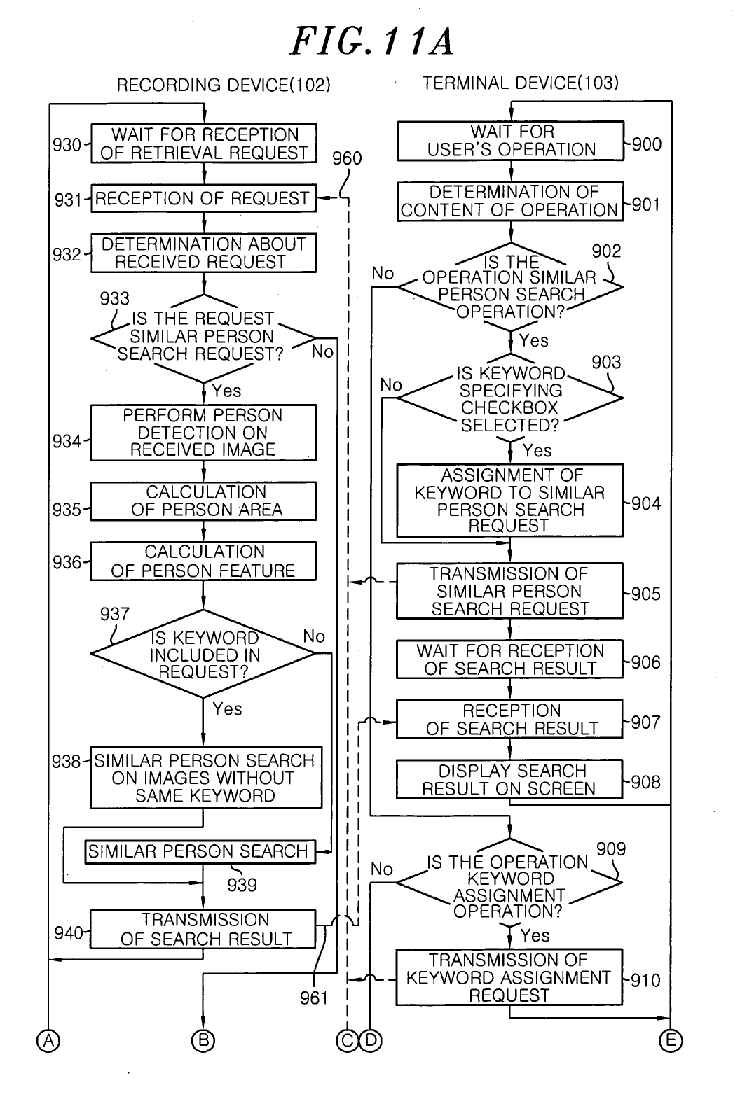

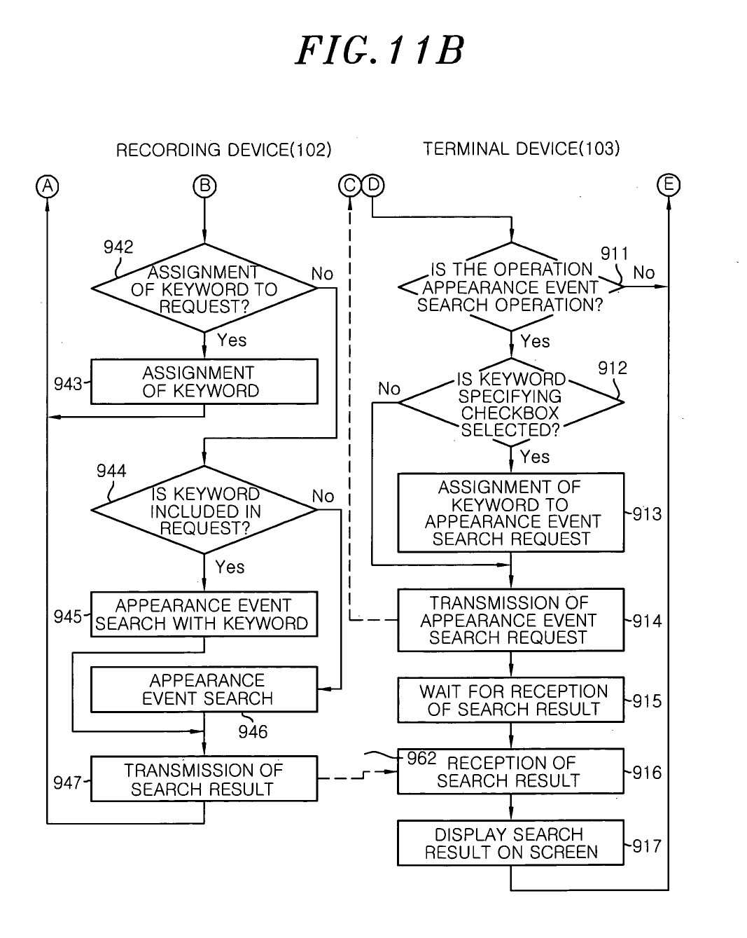

Next, a process of the similar image retrieval system in accordance with the embodiment of the present invention will be described with reference to FIGS. 9 and 11A and 11B.

First, a recording process will be described with reference to FIG. 9.

The recording process is a process that includes processes in the image pickup device 201 and the recording device 102 and a communications process therebetween, and records images from the image pickup device 201 in the recording device 102. The recording process can be carried out at a different time from that of an image playback process or person retrieval process to be described later.

First, the flow of the process in the recording device 102 will be described.

The image transmission/reception unit 210 in the recording device 102 waits to receive image data in step 1000. When an incoming image is detected, the process proceeds to step 1001.

Next, in step 1001, the image transmission/reception unit 210 in the recording device 102 receives the image from the image pickup device 201. The received data contains attribute information, such as an image pickup time and a device index number of image pickup device, as well as image data.

Subsequently, in step 1002, the image recording unit 211 in the recording device 102 records the received the image data and the image ID in a recording medium. The image ID is information for retrieving the image data later. As the image ID, e.g., the unique frame number given sequentially to each frame from the beginning of recording in the recording device 102 can be used as shown in FIG. 5A. Also, in the example shown in FIG. 5A, frame data 302 corresponds to image data.

Thereafter, in step 1003, the person area detecting unit 213 in the recording device 102 performs person area detection on the received image. Person detection is executed by employing an image recognition technique, e.g., a method of detecting a moving object by a differential from a background image and identifying a person based on the shape and the like of the moving object region or a method of retrieving face characteristics of a person in an image using the facial characteristics, such as the layout of main facial components including eyes, nose, mouth and the like and the contrast between the forehead and the eyes. This embodiment may utilize either of these methods.

In succession, in step 1004, the person area detection unit 213 in the recording device 102 makes a determination about a person detection result in step 1003. If a person is detected, the process proceeds to step 1005 and, if not, the process returns to step 1000.

Next, in step 1005, the person area detection unit 213 in the recording device 102 calculates an image area of the person based on the detection result in step 1003. Data of the image area of a face of this person is hereinafter referred to as ‘person image data’.

Subsequently, in step 1006, the person feature extraction unit 214 in the recording device 102 calculates an image feature of the person image data. The image feature is a value representing the pattern of an image which is obtained by using an image recognition technique. The image feature may include, e.g., color distribution of the image, composition distribution of an edge pattern and combinations thereof.

Thereafter, in step 1007, the person feature extraction unit 214 in the recording device 102 records the calculated person feature in the recording medium on the basis of the corresponding image ID.

Next, in step 1008, the attribute information recording unit 216 in the recording device 102 records attribute information, such as an image pickup time and device index numbers of image pickup devices, in the recording medium on the basis of the corresponding image ID. After completion in the recording, the process returns to step 1000.

Next, the flow of the process in the image pickup device 201 will be described.

The image pickup device 201 waits for an output of a picked-up image from an image pickup element, such as a CCD or CMOS, provided in the image pickup unit 241 in step 1010. When the image output is detected, the process proceeds to step 1011.

The image pickup unit 241 performs digital conversion of the picked-up image outputted in step 1011.

In step 1012, the image pickup device 201 firstly stores the digitally converted image in a main memory device and transmits it to the recording device 102 via the network I/F 245 and the network 200.

An arrow 1020 represents communications between the image pickup device 201 and the recording device 102, through which an image is transmitted and received.

Next, an image playback process will be described with reference to FIG. 10.

The image playback process includes processes in the recording device 102 and the terminal device 103 and a communications process therebetween, and reproduces the images recorded in the recording device 102 through the terminal device 103. The image playback process can be carried out at a different time from that of a person retrieval process to be described later.

At first, the flow of the process in the terminal device 103 will be described.

The screen operation detection unit 225 in the terminal device 103 waits for a user's playback operation in step 1100. When the user's playback operation is detected, the process proceeds to step 1101.

The playback operation detected here involves, e.g., pressing each button in the image playback operation area 3003 in FIG. 8A, pressing the play button 3032 in FIG. 8C or the like.

Next, in step 1101, the screen operation detection unit 225 in the terminal device 103 determines an image playback request depending on the user's playback operation. The image playback request, which includes parameters, such as the device index number of an image pickup device to be played, an image ID representing a playback starting position, the type of playback, e.g., play and fast forward, the time direction of playback, the speed of playback, and the like.

Subsequently, in step 1102, the playback image display unit 224 in the terminal device 103 transmits the determined image playback request to the recording device 102 via the network 200.

Thereafter, in step 1103, the playback image display unit 224 in the terminal device 103 waits for the reception of image data. When incoming data is detected, the process goes to step 1104.

Next, in step 1104, the playback image display unit 224 in the terminal device 103 receives data transmitted from the recording device 102.

Subsequently, in step 1105, the playback image display unit 224 in the terminal device 103 determines the content of the received data. If the received content is image data, the process goes to step 1106. If the received content is a playback completion notification, the process returns to step 1100.

Thereafter, in step 1106, the playback image display unit 224 in the terminal device 103 displays the received image on the screen. After completion of the display, the process returns to step 1103.

Next, the flow of the process in the recording device 102 will be described.

First, the image transmission/reception unit 210 in the recording device 102 waits for the reception of an image playback request in step 1110. When an incoming image playback request is detected, the process proceeds to step 1111.

Next, in step 1111, the image transmission/reception unit 210 in the recording device 102 receives the image playback request from the terminal device 103.

Subsequently, in step 1112, the playback control unit 212 in the recording device 102 determines the content of image playback based on the image playback request. The content of image playback includes, e.g., the image ID of an image to be transmitted, the number of images to be transmitted, transmission timings and the like. When the image to be transmitted is a moving image, the image ID may be a frame ID.

In succession, in step 1113, the image recording unit 211 in the recording device 102 takes an image from the recording medium. To take the image out, the image ID of the image to be transmitted is used in the content of image playback.

Next, in step 1114, the image transmission/reception unit 210 in the recording device 102 waits for a transmission time to be reached. The transmission time is determined based on the transmission timing in the content of image playback. When the transmission time is reached, the process proceeds to step 1115.

Subsequently, in step 1115, the image transmission/reception unit 210 in the recording device 102 transmits the image taken out to the terminal device 103 via the network 200.

Thereafter, in step 1116, the playback control unit 212 in the recording unit 102 makes a determination about completion of the image playback. Determination about completion is made depending on whether the transmission of an image satisfactorily matching the determined content of image playback is completed or not. If it is determined to be complete, the process proceeds to step 1117, and, if not, the process goes to step 1118.

In step 1117, the image transmission/reception unit 210 in the recording device 102 transmits a notification of completion of image playback to the terminal device 103 via the network 200. After completion of the transmission, the process returns to step 1110.

In step 1118, the playback control unit 212 in the recording device 102 updates the content of image playback. At this time, the image ID and transmission timing of the image to be transmitted next are updated. For example, in the case of the moving image, the transmission timing is updated by adding, e.g., 33 msec to the transmission timing of the previously transmitted image in case where a transmission rate is, e.g., 30 fps. After completion of the update, the process returns to step 1113. Steps 1113 to 1118 are repeated until the transmission of all images to be transmitted is completed.

Arrows 1120 to 1122 represent communications between the recording device 102 and the terminal device 103.

The arrow 1120 represents that the terminal device 103 transmits an image playback request to the recording device 102. The arrow 1121 represents that the recording device 102 transmits image data to the terminal device 103. The arrow 1122 represents that the recording device 102 sends a notification of completion of image playback to the terminal device 103.

Next, a person retrieval process will be described with reference to FIGS. 11A and 11B.

FIGS. 11A and 11B are flowcharts showing a person retrieval process.

The person retrieval process includes processes in the terminal device 103 and the recording device 102 and a communications process therebetween and retrieves a person desired by the user from image data.

The description of this embodiment will be given mainly with respect to the flows of the processes of the similar person retrieval, the keyword assignment and the appearance event retrieval, while the flows of the processes of a specified operation on a retrieval key image and a user's operation on the checkboxes or specified fields will be omitted.

First, the flow of the process in the terminal device 103 will be described.

The screen operation detection unit 225 in the terminal device 103 waits for a user's screen operation in step 900. When a user's operation is detected, the process proceeds to step 901.

Next, in step 901, the screen operation detection unit 25 in the terminal device 103 determines a content of the user's operation detected.

Subsequently, in step 902, if the screen operation detection unit 225 in the terminal device 103 determines that the content of the user's operation is a similar person retrieval execution operation, the process proceeds to step 903, and, if not, the process goes to step 909.

Thereafter, in step 903, the retrieval request transmission unit 221 in the terminal device 103 checks the state of the keyword specifying checkbox 4021. If the keyword specifying checkbox 4021 is selected, the process proceeds to step 904, otherwise, the process goes to step 905.

In step 904, the retrieval request transmission unit 221 in the terminal device 103 adds, as a keyword, a content entered in the keyword specifying field 4022 to a similar person retrieval request.

In succession, in step 905, the retrieval request transmission unit 221 in the terminal device 103 transmits the similar person retrieval request to the recording device 102 via the network 200. This similar person retrieval request includes narrowing-down retrieval parameters specified in the narrowing-down parameter specifying area 3008 depending on a retrieval key image and specified conditions of the retrieval parameters.

Thereafter, in step 906, the retrieval result reception unit 222 in the terminal device 103 waits for the reception of a retrieval result. When incoming data is detected, the process proceeds to step 907.

Subsequently, in step 907, the retrieval result reception unit 222 in the terminal device 103 receives a similar person retrieval result transmitted from the recording device 102. This similar person retrieval result involves retrieval result images and attribute information data, such as pickup time information of the image, and similarity information between the retrieval key image 3005 and the retrieval result image or the like that are included in each image.

Next, in step 908, the retrieval result display unit 224 in the terminal device 103 displays a received retrieval result on the screen. One example of the display screen is shown in FIG. 8C. Upon completion of the display, the terminal device 103 returns the process to step 900.

Subsequently, in step 909, if the screen operation detection unit 225 in the terminal device 103 determines that the content of the operation is a keyword assignment operation, the process proceeds to step 910, and, if not, the process goes to step 911.

Thereafter, in step 910, the keyword assignment request transmission unit 112 in the terminal device 103 transmits a keyword assignment request to the recording device 102 via the network 200. This keyword assignment request includes the content entered in the keyword specifying field 4022 as a keyword, and the index number of the retrieval result image, whose keyword target checkbox is selected, as a keyword assignment target image.

Next, in step 911, if the screen operation detection unit 225 in the terminal device 103 determines that the content of the user's operation is an appearance event retrieval operation, the process proceeds to step 912, and, if not, the process returns to step 900. Although there are actually processes for other operations, they will be omitted for simplification of the description.

Subsequently, in step 912, the retrieval request transmission unit 221 in the terminal device 103 checks the state of the keyword specifying checkbox 4021. If the keyword specifying checkbox 4021 is selected, the process proceeds to step 913, and if not, the process goes to step 914.

Thereafter, in step 913, the retrieval request transmission unit 221 in the terminal device 103 adds, as a keyword, the content entered in the keyword specifying field 4022 to an appearance event retrieval request.

In succession, in step 914, the retrieval request transmission unit 221 in the terminal device 103 transmits the appearance event retrieval request to the recording device 102 via the network 200. This appearance event retrieval request includes narrowing-down retrieval parameters specified in the narrowing-down parameter specifying area 3008 depending on specified conditions.

Next, in step 915, the retrieval result reception unit 222 in the terminal device 103 waits for the reception of a retrieval result. When incoming data is detected, the process proceeds to step 916.

Subsequently, in step 916, the retrieval result reception unit 222 in the terminal device 103 receives an appearance event retrieval result transmitted from the recording device 102. This appearance event retrieval result involves retrieval result images and attribute information data, such as pickup time information of image included in each image.

Thereafter, in step 917, the retrieval result display unit 224 in the terminal device 103 displays the received retrieval result on the screen. One example of the display screen is shown in FIG. 8G. Upon completion of the display, the terminal device 103 returns the process to step 900.

Now, the flow of the process in the recording device 102 will be described.

Next, the request reception unit 217 of the recording device 102 waits for the reception of a request of the similar image retrieval, keyword assignment, appearance event retrieval or the like from the terminal device 103 in step 930. When an incoming request is detected, the process proceeds to step 931.

Subsequently, in step 931, the request reception unit 217 in the recording device 102 receives the request transmitted from the terminal device 103.

Thereafter, in step 932, the request reception unit 217 in the recording device 102 determines the content of the received request.

Subsequently, in step 933, it is checked whether or not the content of the received request is determined to be a similar person retrieval request. If it is, the process proceeds to step 934, and, if not, the process goes to step 942.

Next, in step 934, the person area detection unit 213 of the recording device 102 performs person detection on the retrieval key image 3005 included in the similar person retrieval request received in step 931. Person detection can be carried out by a well-known conventional technique. Here, the person detection may include detection of the whole person or detection of a face that is a representative particular portion of the person.

Subsequently, in step 935, the person area detection unit 213 in the recording device 102 calculates a person area in the image from the person detection result obtained in step 934, and acquires person image data.

Thereafter, in step 936, the person feature extraction unit 214 in the recording device 102 calculates a person feature of the retrieval key image 3005 from the acquired person image data. The type and calculation method of the feature to be calculated are the same as the well-known conventional technique.

The steps 934 to 936 are performed only when the retrieval key image is obtained from, e.g., a digital still camera, a scanner or the like.

Subsequently, in step 937, the request reception unit 217 in the recording device 102 determines whether a keyword is included in the similar person retrieval request received in step 931. If it is determined that a keyword is included therein, the process proceeds to step 938, and, if not, the process goes to step 939.

Next, in step 938, the similar person retrieval unit 218 in the recording device 102 performs the similar person retrieval based on the person feature of the retrieval key image obtained in step 936. The retrieval is carried out by calculating similarity between the person feature of the retrieval key image 3005 and a person feature of images recorded in the recording device 102 which do not have a keyword same as that included in the similar person retrieval request by comparison and determining a recorded image having more than a certain similarity to the retrieval key image 3005 as a retrieval result image. A retrieval result involves attribute information data, such as pickup time information of the image and the aforementioned similarity information that are included in each image, in addition to a set of retrieval result images. Also, a retrieval result image may be a downscaled version of each image recorded in the recording device 102.

In step 939, the similar person retrieval based on the person feature of the retrieval key image performed by the similar person retrieval unit 218. The similar person retrieval is performed in a similar way as in step 938 except that all the images recorded in the recording device 102a become retrieval target images because it has been determined that no keyword is included in the similar person retrieval request in step 937.

Next, in step 941, the retrieval result transmission unit 220 in the recording device 102 transmits the similar person retrieval result to the terminal device 103 via the network 200. At completion of the transmission, the process returns to step 930.

Subsequently, in step 942, it is checked whether or not the content of the received request is determined to be a keyword assignment request. If it is, the process proceeds to step 943, and, if not, the received request is determined to be an appearance event retrieval request, and thus, the process goes to step 944.

Thereafter, in step 943, the keyword recording unit 110 in the recording device 102 assigns a keyword to a recorded image having an image number included in the keyword assignment request received in step 931. After completion of the assignment, the process returns to step 930.

Next, in step 944, the request reception unit 217 in the recording device 102 determines whether or not a keyword is included in the appearance event retrieval request received in step 931. If it is determined that a keyword is included therein, the process proceeds to step 945, and, if not, the process goes to step 946.

Subsequently, in step 945, the appearance event retrieval unit 219 in the recording device 102 performs an appearance event retrieval based on the keyword and narrowing-down retrieval parameters included in the appearance event retrieval request received in step 931. Here, a recorded image with a keyword matching to the received keyword is retrieved. A retrieval result involves attribute information data, such as pickup time information of image included in each image, in addition to a set of retrieval result images. Also, a retrieval result image may be a downscaled version of each image recorded in the recording device 102.

In step 946, the appearance event retrieval unit 219 in the recording device 102 performs an appearance event retrieval based on narrowing-down retrieval parameters included in the appearance event retrieval request received in step 931.

Next, in step 947, the retrieval result transmission unit 220 in the recording device 102 transmits the appearance event retrieval result to the terminal device 103 via the network 200. After completion of the transmission, the process returns to step 930.

Arrows 960 to 962 represent communications between the recording device 102 and the terminal device 103. The arrow 960 represents that the terminal device 103 transmits the similar person retrieval request, a keyword assignment request, and the appearance event retrieval request to the recording device 102. The arrow 961 represents that the recording device 102 transmits a similar person retrieval result to the terminal device 103. The arrow 962 represents that the recording device 102 transmits the appearance event retrieval result to the terminal device 103.

AS described so far, the similar image retrieval system shown in this embodiment enables effective re-use of a retrieval result using multiple similar person retrievals and a retrieval result using an appearance event retrieval by means of keyword assignment.

The number of the image pickup device 201, the recording device 102, or the terminal device 103 is not limited to one, but multiple image pickup devices and terminal devices may be connected as shown in FIG. 1. Also, although there is only one recording device 102 in FIG. 1, multiple recording devices may be connected.

As shown in FIG. 7, the similar image retrieval system of this embodiment is also efficient in a method of use in which multiple users perform simultaneous parallel similar retrievals for the same person by using multiple terminal devices.

While this embodiment has been described with respect to a configuration in which a person detection process or person feature extraction process using a person retrieval is carried out on the recording device 102, these processes may be carried out by a separate device from the recording device 102 connected via a network.

Moreover, while, in this embodiment, a keyword is defined as a character, the keyword may be a specific number or symbol string.

Further, while, in this embodiment, a checkbox is used to specify a retrieval result image to which a keyword is to be assigned, a specifying method, such as directly selecting the retrieval result image itself by a mouse or the like, may be used.

Furthermore, while this embodiment is targeted for a person retrieval, the present invention is applicable to a general image retrieval, as well as the person retrieval.

What is claimed is:

1. A similar image retrieval system, which stores image data of picked-up images; extracts features of the respective picked-up images to store with the image data; specifies a key image; and retrieves an image having a high similarity with the key image by evaluating similarities between the key image and the picked-up images based on a feature of the key image and those of the picked up images, the system comprising:
a unit for assigning a keyword to each image;
a first image retrieval unit for retrieving a similar image to the key image while excluding an image with the keyword from a retrieval target; and
a second image retrieval unit for retrieving a similar image to the key image while taking only an image with the keyword as a retrieval target.

2. The similar image retrieval system of claim 1, further comprising a plurality of terminal devices for retrieving a similar image to the key image.

3. A similar image retrieval method for a similar image retrieval system, which stores image data of picked-up images; extracts features of the respective picked-up images to store with the image data; specifies a key image; and retrieves an image having a high similarity with the key image by evaluating similarities between the key image and the picked-up images based on a feature of the key image and those of the picked up images, the method comprising:
assigning a keyword to each image;
retrieving a similar image to the key image while excluding an image with the keyword from a retrieval target; and
retrieving a similar image to the key image while taking only an image with the keyword as a retrieval target.
